(19) United States
(12) Patent Application Publication
(10) Pub. No.: US 2024/0248723 A1
(43) Pub. Date: Jul. 25, 2024

(54) PROCESSOR AND METHOD OF CONTROLLING PROCESSOR

(71) Applicant: Preferred Networks, Inc., Tokyo (JP)

(72) Inventor: Ken NAMURA, Tokyo (JP)

(21) Appl. No.: 18/536,760

(22) Filed: Dec. 12, 2023

(30) Foreign Application Priority Data
Jan. 25, 2023 (JP) 2023-009405

(51) Int. Cl. G06F 9/38; G06F 1/28

(52) U.S. Cl. CPC G06F 9/3861; G06F 1/28

(57) ABSTRACT

A processor includes an instruction execution circuit configured to execute an instruction; an instruction supply circuit configured to output the instruction to be executed by the instruction execution circuit; and an instruction selection circuit configured to output the instruction received from the instruction supply circuit to the instruction execution circuit, and output another instruction to the instruction execution circuit in response to detecting that instruction reception from the instruction supply circuit is stopped.

### CROSS-REFERENCE TO RELATED APPLICATIONS

This patent application is based on and claims priority to Japanese Patent Application No. 2023-009405 filed on Jan. 25, 2023, the entire contents of which are incorporated herein by reference.

### TECHNICAL FIELD

The present disclosure relates to a processor and a method of controlling the processor.

### BACKGROUND

A method of suppressing malfunction by causing a processor to execute an instruction code, in which a pre-access instruction is described before an instruction with large power consumption, to gradually increase the power consumption of the processor is known.

However, a method of appropriately controlling the power consumption when execution of an instruction is stopped due to hardware such as a delay in transfer of an instruction to a processor or waiting for execution of an instruction due to data dependency has not been proposed.

### SUMMARY

A processor includes an instruction execution circuit configured to execute an instruction; an instruction supply circuit configured to output the instruction to be executed by the instruction execution circuit; and an instruction selection circuit configured to output the instruction received from the instruction supply circuit to the instruction execution circuit, and output another instruction to the instruction execution circuit in response to detecting that instruction reception from the instruction supply circuit is stopped.

### BRIEF DESCRIPTION OF THE DRAWINGS

FIG. 1 is a block diagram illustrating an example of a configuration of a processor according to an embodiment of the present disclosure;

FIG. 2 is an explanatory diagram illustrating an example of an operation of the processor in FIG. 1;

FIG. 3 is an explanatory diagram illustrating an example of an operation of a processor that does not include the instruction hold unit and the instruction selector in FIG. 1;

FIG. 4 is a block diagram illustrating an example of a configuration of a processor according to another embodiment of the present disclosure;

FIG. 5 is a block diagram illustrating an example of a configuration of a processor according to another embodiment of the present disclosure;

FIG. 6 is an explanatory diagram illustrating an example of an operation of the processor in FIG. 5;

FIG. 7 is a block diagram illustrating an example of a configuration of a processor according to another embodiment of the present disclosure; and

FIG. 8 is a block diagram illustrating an example of a hardware configuration of a computer on which the processor illustrated in FIG. 1 is mounted.

### DETAILED DESCRIPTION OF EMBODIMENTS

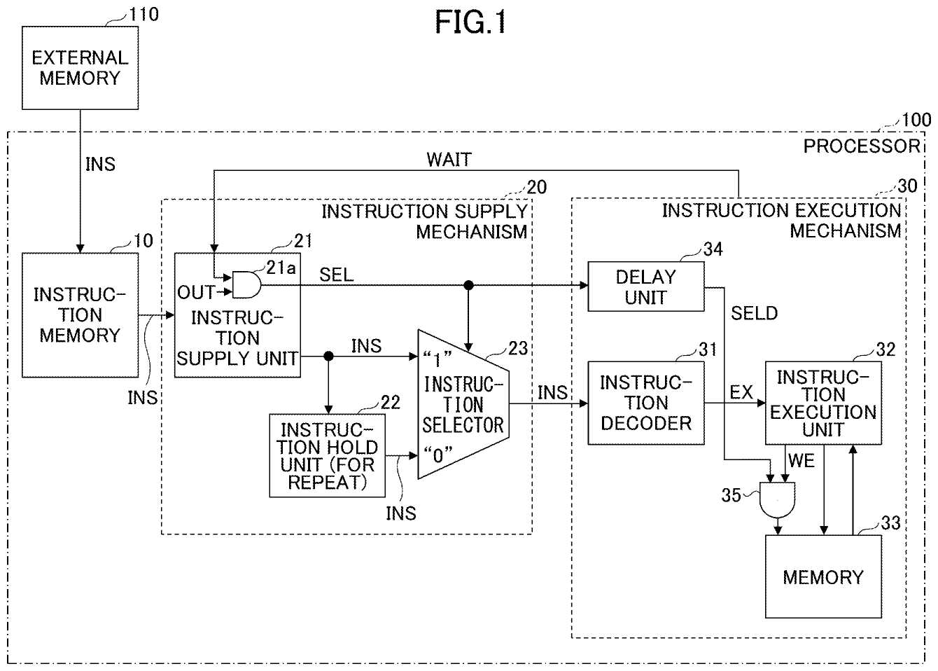

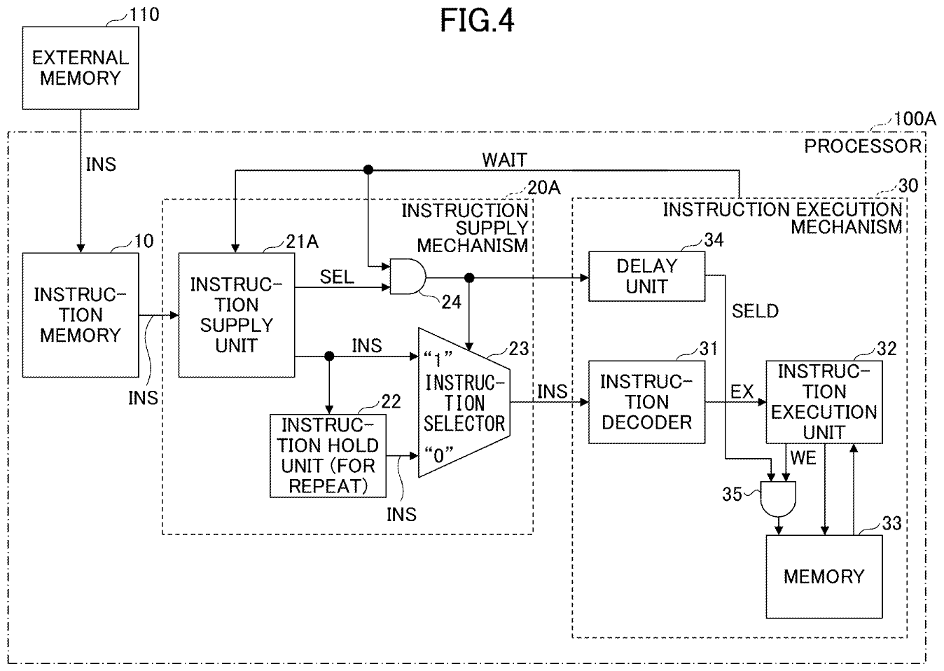

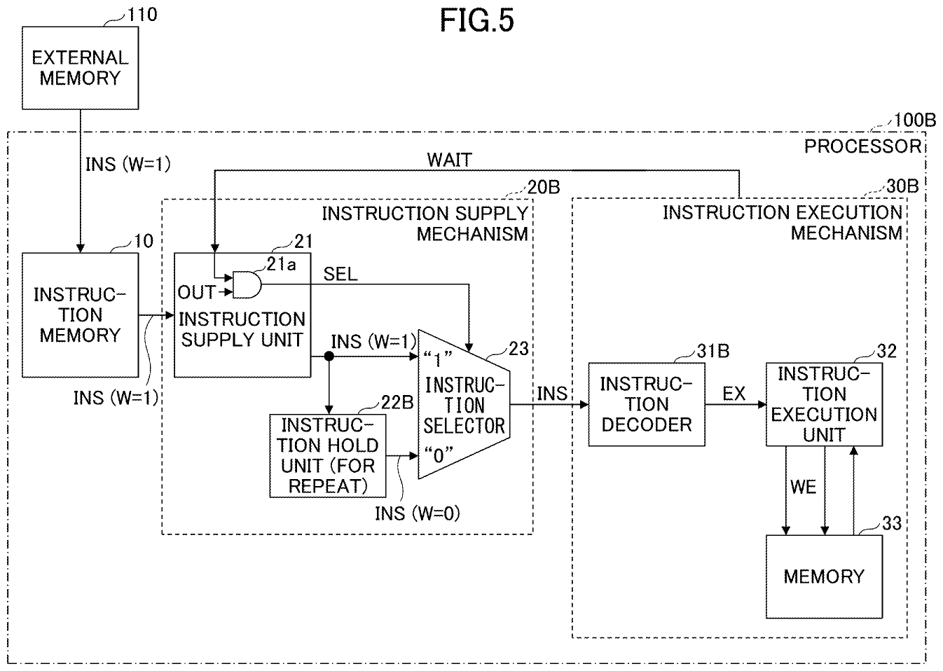

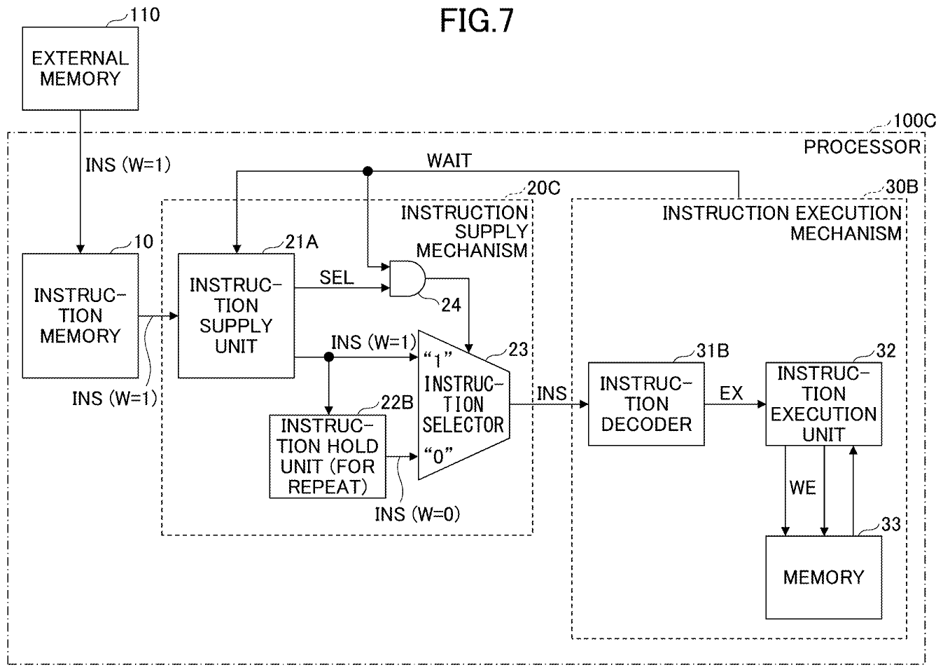

In the following, embodiments of the present disclosure will be described in detail with reference to the drawings. In the following description, signal lines through which signals are transmitted are denoted by the same reference symbols as the names of the signals. Although not particularly limited, a processor described below may be mounted on a computer such as a server and may execute a program (instructions) to perform a convolution operation or the like in training or inference of a neural network. The processor may operate as a single instruction multiple data (SIMD) processor having a large number of arithmetic units that simultaneously execute one instruction. Here, the processor described below may be used for scientific calculation or the like. Additionally, two or more blocks among multiple blocks illustrated by rectangles or trapezoids included in FIG. 1, FIG. 4, FIG. 5, and FIG. 7 may be merged into one block. That is, a function of one block may be implemented by another block. Each of the multiple blocks is realized by, for example, one or more circuits.

FIG. 1 is a block diagram illustrating an example of a configuration of a processor according to an embodiment of the present disclosure. A processor 100 illustrated in FIG. 1 includes an instruction memory 10, an instruction supply mechanism 20, and an instruction execution mechanism 30. The instruction supply mechanism 20 includes an instruction supply unit 21, an instruction hold unit 22, and an instruction selector 23, and performs control to supply an instruction INS to the instruction execution mechanism 30. The instruction execution mechanism 30 includes an instruction decoder 31, an instruction execution unit 32, a memory 33, a delay unit 34, and an AND circuit 35, and performs control to execute the instruction INS received from the instruction supply mechanism 20. Here, the instruction selector 23 may be included in the instruction execution mechanism 30 instead of the instruction supply mechanism 20.

Here, the instruction memory 10, the instruction supply mechanism 20, and the instruction execution mechanism 30 may be implemented as an instruction memory circuit 10, an instruction supply circuit block 20, and instruction execution circuit block 30. The instruction supply unit 21, the instruction hold unit 22, and the instruction selector 23 may be implemented as an instruction supply circuit 21, an instruction hold circuit 22, and an instruction selection circuit 23. The instruction decoder 31, the instruction execution unit 32, the memory 33, and the delay unit 34 may be implemented as an instruction decoder circuit 31, an instruction execution circuit 32, a memory circuit 33, and a delay circuit 34.

The instruction memory 10 holds the instructions INS transferred from an external memory 110 and sequentially outputs the held instructions INS to the instruction supply unit 21. For example, when the transfer of the instruction INS from the external memory 110 externally connected to the processor 100 is delayed and no instruction INS is held, the instruction memory 10 stops the output of the instruction INS to the instruction supply unit 21. Here, the instruction memory 10 may output the instruction INS to the instruction supply unit 21 based on a request from the instruction supply unit 21.

The instruction supply unit 21 outputs the instruction INS received from the instruction memory 10 to the instruction hold unit 22 and the instruction selector 23. For example, the instruction supply unit 21 includes an AND circuit 21a configured to generate a logic of a selection signal SEL based on a wait signal WAIT and an instruction output signal OUT indicating the output of the instruction INS. The AND circuit 21a outputs a low-level selection signal SEL when either the instruction output signal OUT or the wait signal WAIT, or both the instruction signal OUT and the wait signal WAIT are at a low level. The low-level instruction output signal OUT indicates that the instruction supply unit 21 does not output the instruction INS. The low-level wait signal WAIT indicates that the instruction execution unit 32 cannot execute the instruction INS. The AND circuit 21a outputs a high-level selection signal SEL when both the instruction signal OUT and the wait signal WAIT are at a high level. Here, the instruction supply unit 21 may include an instruction queue that holds the instructions INS in the order of reception.

When there is an instruction INS that can be output to the instruction execution mechanism 30, the instruction supply unit 21 generates a high-level instruction output signal OUT. When there is no instruction INS that can be output to the instruction execution mechanism 30 and the output of the instruction INS is to be stopped, the instruction supply unit 21 generates a low-level instruction output signal OUT. When a circuit in the instruction execution mechanism 30 is in a busy state and cannot receive the instruction INS, the instruction execution mechanism 30 outputs the low-level wait signal WAIT. When the instruction INS can be accepted, the instruction execution mechanism 30 outputs the high-level wait signal WAIT. The wait signal WAIT is an example of a wait instruction.

When there is an instruction INS that can be output to the instruction execution mechanism 30 and the high-level wait signal WAIT is received from the instruction execution mechanism 30, the instruction supply unit 21 outputs the instruction INS and the high-level selection signal SEL to the instruction selector 23 and the delay unit 34. When there is no instruction INS to be output to the instruction execution mechanism 30, the instruction supply unit 21 stops the output of the instruction INS, and outputs the low-level selection signal SEL to the instruction selector 23 and the delay unit 34 regardless of the logic of the wait signal WAIT from the instruction execution mechanism 30. The low-level selection signal SEL is a signal for causing the instruction INS held in the instruction hold unit 22 to be output. When receiving the low-level wait signal WAIT from the instruction execution mechanism 30, the instruction supply unit 21 stops the output of the instruction INS and outputs the low-level selection signal SEL to the instruction selector 23 and the delay unit 34 regardless of the presence or absence of the instruction INS that can be output to the instruction execution mechanism 30. The low-level wait signal WAIT is generated by the instruction execution mechanism 30 when the instruction execution unit 32 cannot execute the instruction INS.

The instruction hold unit 22 may hold the instruction INS output from the instruction supply unit 21 as is and output the held instruction INS to the instruction selector 23. The instruction hold unit 22 may change (for example, rewrite) at least a part of the instruction INS output from the instruction supply unit 21, hold the changed instruction INS, and output the held instruction INS to the instruction selector 23. When the instruction INS is not output from the instruction supply unit 21, the instruction hold unit 22 repeatedly outputs, to the instruction selector 23, the instruction INS output last (for example, immediately before) by the instruction supply unit 21 until a new instruction INS is output from the instruction supply unit 21. The instruction INS held by the instruction hold unit 22 is an example of another instruction.

Here, the instruction hold unit 22 may hold multiple substitute instructions INS respectively corresponding to multiple power consumptions in advance and output, to the instruction selector 23, a substitute instruction INS, the power consumption of which is close to the power consumption of the instruction INS output from the instruction supply unit 21. The instruction hold unit 22 that holds the multiple substitute instructions INS has a larger circuit scale than the instruction hold unit 22 that holds the instruction INS output from the instruction supply unit 21 and outputs the instruction INS to the instruction selector 23.

When the selection signal SEL is at a high level (“1”), the instruction selector 23 selects the instruction INS received from the instruction supply unit 21 and outputs the instruction INS to the instruction decoder 31. When the selection signal SEL is at a low level (“0”), the instruction selector 23 selects the instruction INS received from the instruction hold unit 22 and outputs the instruction INS to the instruction decoder 31. The high-level selection signal SEL indicates that the instruction INS is output from the instruction supply unit 21, and the low-level selection signal SEL indicates that the output of the instruction INS from the instruction supply unit 21 is stopped. In other words, the high-level selection signal SEL indicates that the instruction selector 23 receives the instruction INS from the instruction supply unit 21, and the low-level selection signal SEL indicates that the instruction INS reception from the instruction supply unit 21 by the instruction selector 23 is stopped. Here, in an actual operation, the selection of the instruction INS by the instruction selector 23 is determined including the logic of the wait signal WAIT from the instruction execution mechanism 30.

Here, the stopping of the instruction INS reception from the instruction supply unit 21 includes a case where the instruction supply unit 21 cannot output the instruction INS due to a delay in the supply of the instruction INS from the instruction memory 10, a case where the instruction selector 23 do not receive the instruction, a case where the instruction selector 23 cannot receive the instruction INS for some reason even when the instruction supply unit 21 outputs the instruction INS, a case where the instruction supply unit 21 stops the output of the instruction based on detecting that the instruction execution unit 32 cannot execute the instruction INS due to data dependency, and the like. Also in the following description, the stopping of the instruction INS reception from the instruction supply unit 21 (the same applies to the instruction supply unit 21A in FIG. 4 and FIG. 7) includes a case where the instruction INS cannot be output, a case where the instruction selector 23 does not receive the instruction, a case where the instruction selector 23 cannot receive the instruction INS output by the instruction supply unit 21, a case where the instruction supply unit 21 stops the output of the instruction based on detecting that the instruction execution unit 32 cannot execute the instruction INS, and the like. When the output of the instruction INS from the instruction supply unit 21 is stopped, the instruction selector 23 selects another instruction held in the instruction hold unit 22 and outputs the selected instruction to the instruction execution unit 32 via the instruction decoder 31.

Even when the output of the instruction INS from the instruction supply unit 21 is interrupted, the instruction hold unit 22 and the instruction selector 23 can repeatedly output, to the instruction decoder 31, the instruction INS that has been output last by the instruction supply unit 21. This allows the instruction execution unit 32 to execute the instruction INS without interruption even when the output of the instruction INS from the instruction supply unit 21 is interrupted.

Therefore, even when the output of the instruction INS from the instruction supply unit 21 is interrupted, the processor 100 can prevent the power consumption from rapidly decreasing and suppress power supply noise from occurring. As a result, the processor 100 can be prevented from malfunctioning due to power supply noise, and the reliability of the processor 100 can be improved. With this, even when the output of the instruction INS from the instruction supply unit 21 is stopped due to the hardware or the operation of the processor 100, which cannot be assumed at the time of coding the instruction INS, the power consumption can be prevented from rapidly decreasing.

The instruction execution mechanism 30 outputs the low-level wait signal WAIT when a new instruction INS cannot be processed because the instruction execution unit 32 is executing or waiting to execute the instruction INS, for example. The execution wait of the instruction INS occurs due to data queuing or the like caused by data dependency between the instructions INS. Additionally, the instruction execution mechanism 30 outputs the low-level wait signal WAIT until the instruction execution unit 32 receives data to be used to execute the instruction INS from the memory 33, for example.

For example, the memory 33 is a register file. Here, the memory 33 may include the register file connected to the instruction execution unit 32 and an internal memory connected to the register file. The memory 33 is connected to another memory such as the external memory 110 via a bus, which is not illustrated.

The delay unit 34 receives the selection signal SEL, delays the output of the selection signal by the sum of the decoding time by the instruction decoder 31 and the execution time of the instruction INS by the instruction execution unit 32, and outputs the selection signal to the AND circuit 35 as a delay selection signal SELD. The logic of the delay selection signal SELD is the same as the logic of the selection signal SEL.

The instruction decoder 31 decodes the instruction INS received from the instruction selector 23, generates control information EX for causing the instruction execution unit 32 to execute the instruction INS, and outputs the generated control information EX to the instruction execution unit 32. Here, when the instruction execution unit 32 includes multiple types of execution units, the instruction decoder 31 outputs the control information EX to the execution unit determined according to the decoding result of the instruction INS.

In the present embodiment, the instruction hold unit 22 outputs the instruction INS output from the instruction supply unit 21 as is to the instruction selector 23. Therefore, the instruction decoder 31 can decode the instruction INS output from the instruction supply unit 21 and the instruction INS output from the instruction hold unit 22 without distinguishing them from each other. Therefore, the processor 100 can operate using the existing instruction set architecture, and the development period of the processor 100 can be reduced in comparison with a case where a new instruction set is designed.

Here, when the instruction INS includes control information (decoded control information) that can be directly executed by the instruction execution unit 32, the instruction execution mechanism 30 need not include the instruction decoder 31. In this case, the instruction INS output from the instruction selector 23 is directly output to the instruction execution unit 32.

The instruction execution unit 32 includes, for example, an arithmetic unit. The instruction execution unit 32 executes the instruction by using the data held in the memory 33 according to the control information EX, and outputs a high-level write enable signal WE for writing an execution result data or an execution result such as a status flag to the memory 33. For example, the high-level write enable signal WE indicates permission to write the execution result to the memory 33.

When the delay selection signal SELD is at the high level, the AND circuit 35 outputs the high-level write enable signal WE from the instruction execution unit 32 to the memory 33, and writes the execution result to the memory 33. When the delay selection signal SELD is at the low level, the AND circuit 35 prevents the instruction execution unit 32 from outputting the high-level write enable signal WE to the memory 33. The AND circuit 35 prevents the execution result obtained by the instruction execution unit 32 executing the instruction INS held in the instruction hold unit 22 from being written to the memory 33.

This can prevent the execution result obtained by the instruction execution unit 32 executing the instruction INS output from the instruction hold unit 22 from being written to the memory 33. That is, the execution of the instruction INS that is not included in the instruction sequence supplied from the instruction memory 10 prevents the context such as the execution result data or the status flag held in the data register or the status register from being rewritten.

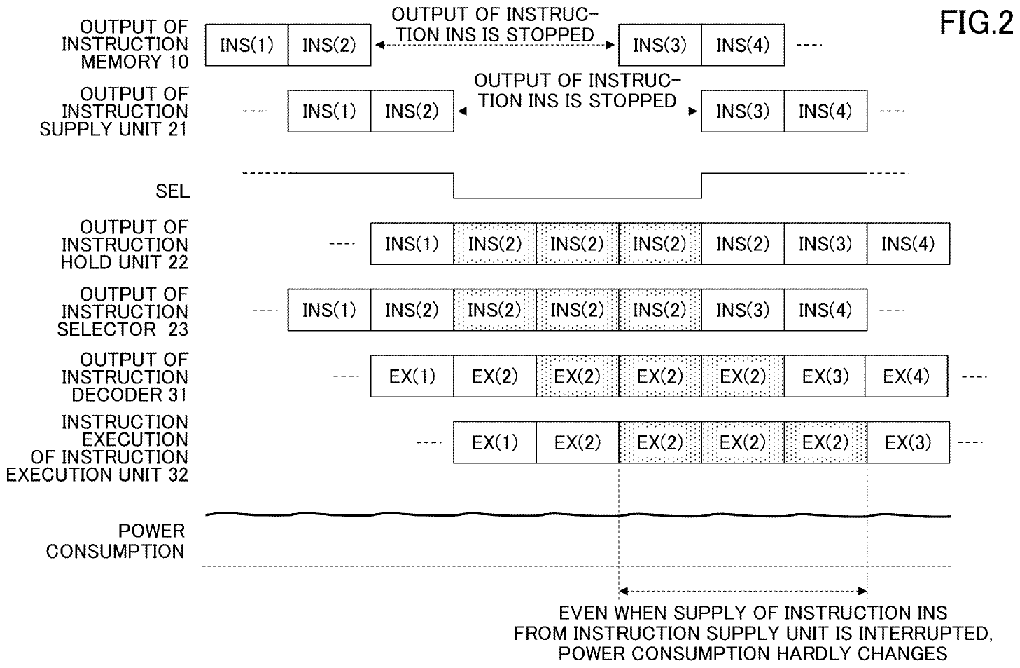

FIG. 2 is an explanatory diagram illustrating an example of the operation of the processor 100 illustrated in FIG. 1. In FIG. 2, for simplification of the description, it is assumed that the instruction memory 10, the instruction supply unit 21, and the instruction hold unit 22 output the instruction INS for each cycle, the instruction decoder 31 decodes the instruction INS for each cycle, and the instruction execution unit 32 executes the instruction INS for each cycle.

A number added in parentheses after each instruction INS indicates an identification number of the instruction INS output from the instruction memory 10. A number added in parentheses after each control information EX indicates an identification number corresponding to the identification number of the instruction INS. The instruction INS represented in a shade indicates the instruction INS output from the instruction hold unit 22, and the control information EX represented in a shade indicates the control information EX generated by decoding the instruction INS represented in a shade.

The instruction memory 10 sequentially outputs the instructions INS to the instruction supply unit 21, and stops the output of the instructions INS when there is no instruction INS to be output. The instruction supply unit 21 sequentially outputs the instructions INS received from the instruction memory 10. When the output of the instruction INS from the instruction memory 10 is stopped, or when receiving the low-level wait signal WAIT from the instruction supply mechanism 20, the instruction supply unit 21 stops the output of the instruction INS. In FIG. 2, the instruction supply unit 21 stops the output of the instruction INS to the instruction hold unit 22 and the instruction selector 23 based on the stopping of the output of the instruction INS from the instruction memory 10. The instruction supply unit 21 sets the selection signal SEL to the low level while the output of the instruction INS is stopped.

The instruction hold unit 22 outputs the instruction INS output from the instruction supply unit 21 to the instruction selector 23, and when the instruction INS is not output from the instruction supply unit 21, the instruction hold unit 22 repeatedly outputs the instruction INS output last from the instruction supply unit 21 to the instruction selector 23. The instruction selector 23 outputs the instruction INS from the instruction supply unit 21 to the instruction decoder 31 while the selection signal SEL is at the high level, and outputs the instruction INS from the instruction hold unit 22 to the instruction decoder 31 while the selection signal SEL is at the low level.

The instruction selector 23 outputs another instruction INS held in the instruction hold unit 22 to the instruction execution unit 32 via the instruction decoder 31 multiple times until the output of the instruction INS from the instruction supply unit 21 is restarted. That is, when the reception of the instruction INS from the instruction supply unit 21 is stopped, the instruction selector 23 outputs another instruction received from the instruction hold unit 22 so that the instruction execution unit 32 continuously executes the same instruction INS twice or more. When another instruction INS held in the instruction hold unit 22 is output multiple times, the content executed by another instruction may be the same in each of the multiple times or may be different in at least two of the multiple times.

The instruction decoder 31 sequentially decodes the instructions INS received from the instruction selector 23, and outputs the decoded instructions as the control information EX to the instruction execution unit 32. Then, the instruction execution unit 32 sequentially executes the instructions INS based on the control information EX.

In the present embodiment, even if the output of the instruction INS from the instruction supply unit 21 is interrupted, the instruction execution unit 32 can execute the instruction INS without interruption by using the instruction INS output from the instruction hold unit 22. Thus, even if the output of the instruction INS from the instruction supply unit 21 is interrupted, the power consumption hardly changes. Therefore, the power consumption can be prevented from rapidly decreasing due to the interruption of the output of the instruction INS from the instruction supply unit 21, and occurrence of power supply noise can be suppressed. As a result, the processor 100 can be prevented from malfunctioning due to power supply noise, and the reliability of the processor 100 can be improved.

Additionally, when the output of the instruction INS from the instruction supply unit 21 is interrupted, the instruction execution unit 32 repeatedly executes the instruction INS executed immediately before. Thus, in comparison with a case where an instruction unrelated to the instruction INS executed immediately before is executed when the output of the instruction INS is interrupted, a fluctuation in the power consumption can be reduced and occurrence of power supply noise can be further suppressed.

Further, the instruction execution unit 32 continues to execute the instruction INS output from the instruction hold unit 22 until the output of the instruction INS is restarted by the instruction supply unit 21. Therefore, in comparison with a case where the execution of the instruction INS is suddenly started, the power consumption can be prevented from rapidly increasing, and occurrence of power supply noise can be further suppressed. Here, when the processor 100 is a SIMD processor having a large number of arithmetic units simultaneously operating, a more remarkable effect can be obtained.

Here, another instruction INS supplied to the instruction execution unit 32 via the instruction decoder 31 when the supply of the instruction INS from the instruction supply unit 21 is stopped may be the instruction INS output from the instruction supply unit 21 immediately before the supply of the instruction INS is stopped or may be the instruction INS held in the instruction hold unit 22 immediately before the supply of the instruction INS is stopped. Additionally, the instruction INS need not be the immediately preceding instruction INS as long as the instruction INS can suppress a fluctuation in the power consumption. Furthermore, another instruction INS supplied to the instruction execution unit 32 via the instruction decoder 31 when the supply of the instruction INS from the instruction supply unit 21 is stopped may be determined based on the power consumption of one or more instructions INS executed before the supply of the instruction INS is stopped. For example, another instruction INS supplied to the instruction execution unit 32 may be determined based on the average power consumption of the instructions INS executed before the supply of the instruction INS is stopped.

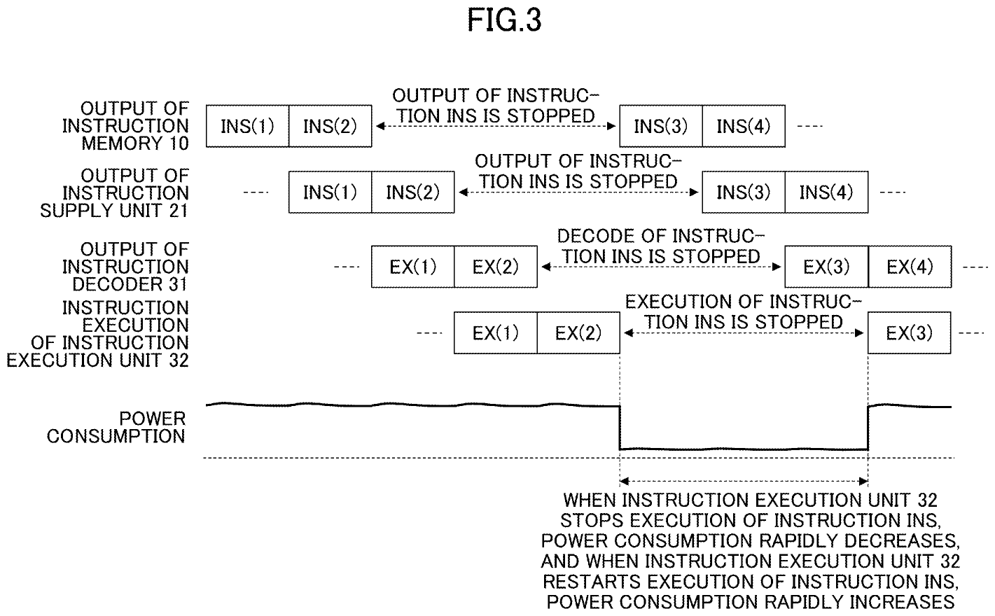

FIG. 3 is an explanatory diagram illustrating an example of an operation of a processor that does not include the instruction hold unit 22 and the instruction selector 23 of FIG. 1. Detailed descriptions of elements substantially the same as those of FIG. 2 will be omitted. The instructions INS respectively output from the instruction memory 10 and the instruction supply unit 21 are the same as those in FIG. 2.

In FIG. 3, when the instruction supply unit 21 does not output the instruction INS, the instruction decoder 31 stops the decoding of the instruction INS, and the instruction execution unit 32 stops the execution of the instruction INS. Thus, the power consumption of the processor rapidly decreases while the instruction execution unit 32 stops the execution of the instruction INS. Additionally, when the instruction execution unit 32 restarts the execution of the instruction INS, the power consumption of the processor rapidly increases. When the power consumption rapidly changes, power supply noise increases, and the processor may malfunction due to power supply noise. In recent years, the operating voltage of the processor tends to decrease and the operating margin of the processor tends to decrease. In order to stably operate the processor, it is preferable that the fluctuation amount of the power supply is small.

FIG. 4 is a block diagram illustrating an example of a configuration of a processor according to another embodiment of the present disclosure. Elements the same as those in FIG. 1 are denoted by the same reference symbols and detailed descriptions thereof will be omitted. A processor 100A illustrated in FIG. 4 includes an instruction supply mechanism 20A instead of the instruction supply mechanism 20 illustrated in FIG. 1. The instruction supply mechanism 20A includes an instruction supply unit 21A instead of the instruction supply unit 21 illustrated in FIG. 1, and additionally includes an AND circuit 24. Here, the instruction selector 23 may be included in the instruction execution mechanism 30 instead of the instruction supply mechanism 20A. The instruction supply mechanism 20A and the instruction supply unit 21A may be implemented as an instruction supply circuit block 20A and an instruction supply circuit 21A.

The instruction supply unit 21A has substantially the same configuration and function as those of the instruction supply unit 21 of FIG. 1 except that the instruction supply unit 21A does not include the AND circuit 21a. When there is an instruction to be output to the instruction execution mechanism 30 in conjunction with when the high-level wait signal WAIT is received from the instruction execution mechanism 30, the instruction supply unit 21A outputs the instruction INS and the high-level selection signal SEL. When there is no instruction to be output to the instruction execution mechanism 30 or when the low-level wait signal WAIT is received from the instruction execution mechanism 30, the instruction supply unit 21A stops the output of the instruction INS and outputs the low-level selection signal SEL.

The AND circuit 24 is provided instead of the AND circuit 21a of FIG. 1. When the wait signal WAIT is at a high level, the AND circuit 24 outputs the logic of the selection signal SEL output from the instruction supply unit 21A to the instruction selector 23 and the delay unit 34. When the wait signal WAIT is at the low level, the AND circuit 24 outputs the low level signal to the instruction selector 23 and the delay unit 34 regardless of the logic of the selection signal SEL output from the instruction supply unit 21A. The AND circuit 24 is an example of a selection control unit. The selection control unit may be implemented as a selection control circuit.

Here, the function of the AND circuit 24 may be provided in the instruction selector 23. In this case, the instruction selector 23 receives the selection signal SEL and the wait signal WAIT, and determines which of the instruction INS from the instruction supply unit 21A and the instruction INS from the instruction hold unit 22 is to be selected.

The operation of the processor 100A is substantially the same as that of the processor 100 illustrated in FIG. 2. However, in the operation of the processor 100A, the waveform of the selection signal SEL illustrated in FIG. 2 indicates the waveform of the signal output from the AND circuit 24. Also in the present embodiment, substantially the same effect as that of the embodiment illustrated in FIG. 1 and FIG. 2 can be obtained.

FIG. 5 is a block diagram illustrating an example of a configuration of a processor according to another embodiment of the present disclosure. Elements the same as those in FIG. 1 are denoted by the same reference symbols and detailed descriptions thereof will be omitted. A processor 100B illustrated in FIG. 5 includes an instruction supply mechanism 20B and an instruction execution mechanism 30B instead of the instruction supply mechanism 20 and the instruction execution mechanism 30 illustrated in FIG. 1.

The instruction supply mechanism 20B has substantially the same configuration and function as those of the instruction supply mechanism 20 illustrated in FIG. 1 except that the instruction supply mechanism 20B includes an instruction hold unit 22B instead of the instruction hold unit 22 illustrated in FIG. 1. The instruction execution mechanism 30B has substantially the same configuration and function as those of the instruction execution mechanism 30 of FIG. 1 except that the instruction execution mechanism 30B includes an instruction decoder 31B instead of the instruction decoder 31 of FIG. 1 and does not include the delay unit 34 and the AND circuit 35. The instruction supply mechanism 20B, the instruction hold unit 22B, the instruction execution mechanism 30B, and the instruction decoder 31B may be implemented as an instruction supply circuit block 20B, an instruction hold circuit 22B, an instruction execution circuit block 30B, and an instruction decoder circuit 31B.

The processor 100B has an instruction set architecture in which write information W indicating whether to write an execution result of the instruction INS executed by the instruction execution unit 32 to the memory 33 is added to each instruction. For example, the write information W of “1” indicates permission of writing the context to the memory 33, and the write information W of “0” indicates prohibition of writing the context to the memory 33. Hereinafter, the instruction INS including the write information W of “1” is represented by the instruction INS (W=1), and the instruction INS including the write information W of “0” is represented by the instruction INS (W=0).

The instruction INS (W=1) is stored in the external memory 110. The instruction memory 10 holds the instruction INS (W=1) transferred from the external memory 110 and outputs the held instruction INS (W=1) to the instruction supply unit 21.

The instruction supply unit 21 sequentially outputs the instructions INS (W=1) received from the instruction memory 10 to the instruction hold unit 22B and the instruction selector 23. When outputting the instruction INS (W=1), the instruction supply unit 21 outputs, to the instruction selector 23 together with the instruction INS (W=1), the high-level selection signal SEL for causing the instruction selector 23 to select the instruction INS (W=1). When the supply of the instruction INS (W=1) from the instruction memory 10 is stopped or when the low-level wait signal WAIT is received from the instruction execution mechanism 30, the instruction supply unit 21 outputs, to the instruction selector 23, the low-level selection signal SEL for causing the instruction selector 23 to select the instruction INS (W=0) output from the instruction hold unit 22B.

When receiving the instruction INS (W=1) from the instruction supply unit 21, every time the instruction INS (W=1) is received, the instruction hold unit 22B changes the write information W to the write information W that prohibits the writing of the context (=0), and outputs the instruction INS to the instruction selector 23 as the instruction INS (W=0). As described above, the holding of the instruction INS output by the instruction supply unit 21 in the instruction hold unit 22B includes holding the instruction INS by changing the instruction INS (W=1) output by the instruction supply unit 21 to the instruction INS (W=0) for preventing the execution result of the instruction INS from being written to the memory 33. The instruction INS (W=0) held in the instruction hold unit 22B is an example of another instruction. When the instruction hold unit 22B does not receive the instruction INS (W=1) from the instruction supply unit 21, the instruction hold unit 22B repeatedly outputs the instruction INS (W=0) corresponding to the instruction INS (W=1) received last (immediately before) to the instruction selector 23 until a new instruction INS (W=1) is received.

When the selection signal SEL is at the high level, the instruction selector 23 selects the instruction INS (W=1) output from the instruction supply unit 21 and outputs the instruction INS to the instruction decoder 31B as the instruction INS to be decoded. When the selection signal SEL is at the low level, the instruction selector 23 selects the instruction INS (W=0) output from the instruction hold unit 22B and outputs the instruction INS to the instruction decoder 31B as the instruction INS to be decoded.

The instruction decoder 31B decodes the instruction INS (including W=1 or W=0) received from the instruction selector 23 to generate the control information EX executable by the instruction execution unit 32, and outputs the generated control information EX to the instruction execution unit 32. The control information EX includes the write information W included in the instruction INS (W=1) output from the instruction supply unit 21 or included in the instruction INS (W=0) output from the instruction hold unit 22B.

When the write information W of “1” is included in the control information EX, the instruction execution unit 32 executes the instruction by using the data held in the memory 33 according to the control information EX, and outputs the high-level write enable signal WE to the memory 33 together with the execution result. This allows the execution result data or the context such as the status flag to be stored in the memory 33.

When the write information W of “0” is included in the control information EX, the instruction execution unit 32 executes the instruction by using the data held in the memory 33 according to the control information EX, and outputs the low-level write enable signal WE to the memory 33 together with the execution result. In this case, the execution result is not stored in the memory 33, and the context in the memory 33 is maintained.

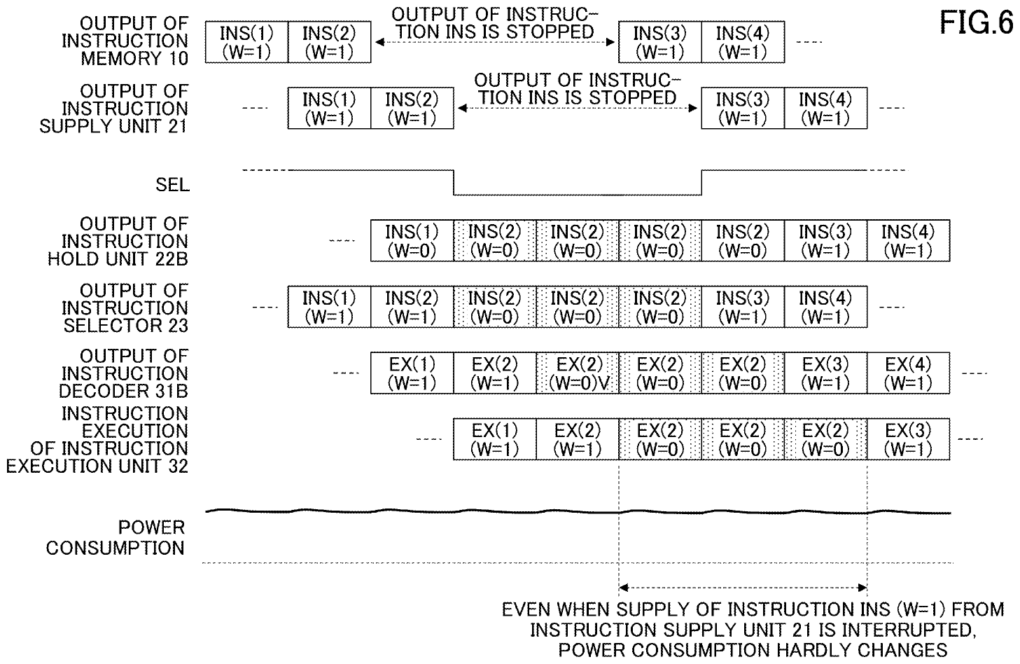

FIG. 6 is an explanatory diagram illustrating an example of the operation of the processor 100B illustrated in FIG. 5. Detailed descriptions of operations substantially the same as those in FIG. 2 will be omitted. In FIG. 6, the instruction INS and the control information EX including the write information W of “1” are denoted by INS (W=1) and EX (W=1), respectively. The instruction INS and the control information EX including the write information W of “0” are denoted by INS (W=0) and EX (W=0), respectively.

Also in FIG. 6, as in FIG. 2, even if the output of the instruction INS (W=1) from the instruction supply unit 21 is interrupted, the instruction execution unit 32 can execute the instructions INS without interruption by using the instruction INS (W=0) output from the instruction hold unit 22B. Thus, even if the output of the instruction INS (W=1) from the instruction supply unit 21 is interrupted, the power consumption hardly changes. Therefore, the power consumption can be prevented from rapidly decreasing due to the interruption of the output of the instruction INS (W=1) from the instruction supply unit 21, and occurrence of power supply noise can be suppressed. As a result, the processor 100B can be prevented from malfunctioning due to power supply noise, and the reliability of the processor 100B can be improved.

Although there is a difference between the instruction INS (W=1) and the instruction INS (W=0) in whether the execution result is written to the memory 33, the instruction execution unit 32 executes each of the instruction INS (W=1) and the instruction INS (W=0). Thus, the power consumption during the execution of the instruction INS (W=0) is substantially the same as the power consumption during the execution of the instruction INS (W=1), and there is almost no fluctuation in the power consumption when the instruction INS (W=0) is executed after the execution of the instruction INS (W=1).

Further, the instruction execution unit 32 continues to execute the instruction INS (W=0) output from the instruction hold unit 22B until the output of the instruction INS is restarted by the instruction supply unit 21. Thus, the increase amount of the power consumption, obtained when the execution of the instruction INS (W=1), output when the output is restarted by the instruction supply unit 21, is started, can be suppressed, and occurrence of power supply noise can be suppressed.

FIG. 7 is a block diagram illustrating an example of a configuration of a processor according to another embodiment of the present invention. Elements the same as those in FIG. 1 and FIG. 5 are denoted by the same reference symbols and detailed descriptions thereof will be omitted. A processor 100C illustrated in FIG. 7 includes an instruction supply mechanism 20C instead of the instruction supply mechanism 20B illustrated in FIG. 5. The instruction supply mechanism 20C includes the instruction hold unit 22B illustrated in FIG. 5 instead of the instruction hold unit 22 of the instruction supply mechanism 20A illustrated in FIG. 4. Here, the instruction selector 23 may be included in the instruction execution mechanism 30B, not in the instruction supply mechanism 20C. The instruction supply mechanism 20C may be implemented as an instruction supply circuit block 20C.

As in the processor 100B of FIG. 5, the processor 100C has an instruction set architecture in which the write information W indicating whether to write the execution result of the instruction INS executed by the instruction execution unit 32 to the memory 33 is added to each instruction. The operations of the processor 100C are substantially the same as those of the processor 100B illustrated in FIG. 6. However, in the operations of the processor 100C, the waveform of the selection signal SEL illustrated in FIG. 6 indicates the waveform of the signal output from the AND circuit 24. Also in the present embodiment, effects substantially the same as those of the embodiment illustrated in FIG. 5 and FIG. 6 can be obtained.

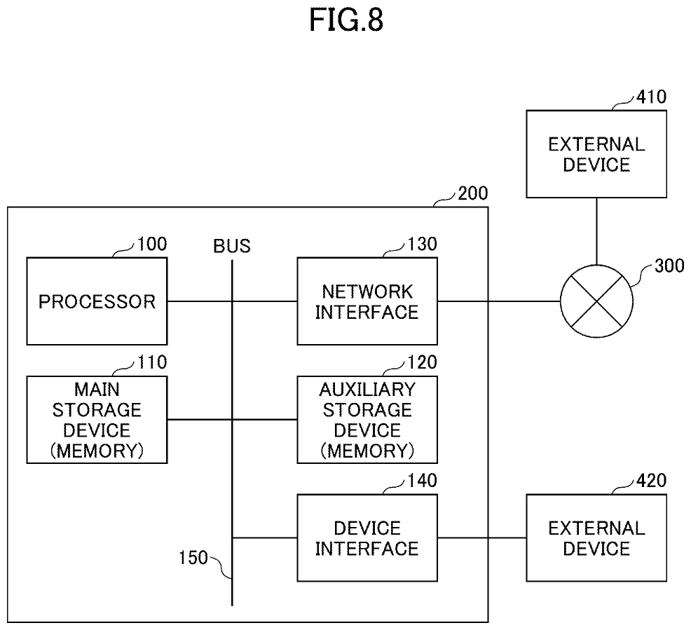

FIG. 8 is a block diagram illustrating an example of a hardware configuration of a computer on which the processor 100 illustrated in FIG. 1 is mounted. In FIG. 8, as an example, the computer may be realized as a computer 200 including a processor 100, a main storage device 110 (a memory), an auxiliary storage device 120 (a memory), a network interface 130, and a device interface 140, which are connected to each other via a bus 150. Here, the computer 200 may include the processor 100A illustrated in FIG. 4, the processor 100B illustrated in FIG. 5, or the processor 100C illustrated in FIG. 7, instead of the processor 100. For example, the main storage device 110 corresponds to the external memory 110 illustrated in FIG. 1.

The computer 200 of FIG. 8 includes one of each component, but may include two or more of the same components. Additionally, although one computer 200 is illustrated in FIG. 8, software may be installed in multiple computers, and each of the multiple computers may execute the same part or different parts of the processing of the software. In this case, a form of distributed computing in which the computers communicate with each other via the network interface 130 or the like to perform the processing may be employed. That is, a system may be configured to implement functions by one or more computers 200 executing instructions stored in one or more storage devices. Additionally, the information transmitted from a terminal may be processed by one or more computers 200 provided on a cloud, and the processing result may be transmitted to the terminal.

Various operations may be executed in parallel processing using one or more processors 100 mounted on the computer 200 or using multiple computers 200 via a network. Additionally, various operations may be distributed to multiple arithmetic cores in the processor 100 to be executed in parallel processing. Additionally, some or all of the processes, means, and the like of the present disclosure may be realized by at least one of a processor or a storage device provided on a cloud that can communicate with the computer 200 via a network. As described, each device in the above-described embodiments may be in a form of parallel computing by one or more computers.

The processor 100 may be an electronic circuit (a processing circuit, processing circuitry, a CPU, a GPU, an FPGA, an ASIC, or the like) that performs at least one of computer control or operations. Additionally, the processor 100 may be any of a general-purpose processor, a dedicated processing circuit designed to execute a specific operation, and a semiconductor device including both a general-purpose processor and a dedicated processing circuit. Additionally, the processor 100 may include an optical circuit or may include an arithmetic function based on quantum computing.

The processor 100 may perform arithmetic processing based on data or software input from each device or the like of the internal configuration of the computer 200, and may output an arithmetic result or a control signal to each device or the like. The processor 100 may control respective components constituting the computer 200 by executing an operating system (OS), an application, or the like of the computer 200.

The main storage device 110 may store instructions executed by the processor 100, various data, and the like, and information stored in the main storage device 110 may be read by the processor 100. The auxiliary storage device 120 is a storage device other than the main storage device 110. Here, these storage devices indicate any electronic components capable of storing electronic information, and may be semiconductor memories. The semiconductor memory may be either a volatile memory or a nonvolatile memory. A storage device for storing various data and the like in the computer 200 may be realized by the main storage device 110 or the auxiliary storage device 120, or may be realized by a built-in memory built in the processor 100.

When the computer 200 includes at least one storage device (memory) and at least one processor 100 connected (coupled) to the at least one storage device, the at least one processor 100 may be connected to one storage device. Additionally, at least one storage device may be connected to one processor 100. Additionally, a configuration in which at least one processor 100 among the multiple processors 100 is connected to at least one storage device among the multiple storage devices may be included. Additionally, this configuration may be realized by storage devices and the processors 100 included in multiple computers 200. Furthermore, a configuration in which the storage device is integrated with the processor 100 (for example, an L1 cache or a cache memory including an L2 cache) may be included.

The network interface 130 is an interface for connecting to the communication network 300 by wire or wirelessly. As the network interface 130, an appropriate interface such as one conforming to an existing communication standard may be used. The network interface 130 may exchange information with an external device 410 connected via the communication network 300. Here, the communication network 300 may be any one of a wide area network (WAN), a local area network (LAN), a personal area network (PAN), and the like, or a combination thereof, as long as information is exchanged between the computer 200 and the external device 410. Examples of the WAN include the Internet and the like, and examples of the LAN include IEEE802.11, Ethernet (registered trademark), and the like. Examples of the PAN include Bluetooth (registered trademark), Near Field Communication (NFC), and the like.

The device interface 140 is an interface such as a USB that is directly connected to an external device 420.

The external device 410 is a device connected to the computer 200 via a network. The external device 420 is a device directly connected to the computer 200.

The external device 410 or the external device 420 may be, for example, an input device. The input device is, for example, a device such as a camera, a microphone, a motion capture device, various sensors, a keyboard, a mouse, a touch panel, or the like, and gives acquired information to the computer 200. Alternatively, the device may be a device including an input unit, a memory, and a processor, such as a personal computer, a tablet terminal, or a smartphone.

Additionally, the external device 410 or the external device 420 may be, for example, an output device. The output device may be, for example, a display device such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 410 or the external device 420 may be a storage device (a memory). For example, the external device 410 may be a network storage or the like, and the external device 420 may be a storage such as an HDD.

Additionally, the external device 410 or the external device 420 may be a device having some functions of the components of the computer 200. That is, the computer 200 may transmit a part or all of the processing result to the external device 410 or the external device 420, or may receive a part or all of the processing result from the external device 410 or the external device 420.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

Although the embodiments of the present disclosure have been described in detail above, the present disclosure is not limited to the individual embodiments described above. Various additions, modifications, replacements, partial deletions, and the like can be made without departing from the conceptual idea and spirit of the present invention derived from the contents defined in the claims and equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

Aspects of the present disclosure are as follows, for example.

<1> A processor including an instruction execution unit configured to execute an instruction; an instruction supply unit configured to output the instruction to be executed by the instruction execution unit; and an instruction selector configured to output the instruction received from the instruction supply unit to the instruction execution unit, and output another instruction to the instruction execution unit in response to detecting that instruction reception from the instruction supply unit is stopped.
<2> The processor as described in <1>, wherein the another instruction is at least one of an instruction based on a first instruction received from the instruction supply unit before the instruction reception from the instruction supply unit is stopped or an instruction determined based on power consumption of the first instruction.
<3> The processor as described in <2>, wherein the another instruction is an instruction based on the instruction received from the instruction supply unit immediately before the instruction reception from the instruction supply unit is stopped.
<4> The processor as described in <1>, wherein the another instruction is an instruction determined based on power consumption.
<5> The processor as described in <1>, wherein the instruction selector outputs the another instruction so that the instruction execution unit continuously executes the same instruction two or more times, in response to detecting that the instruction reception from the instruction supply unit is stopped.
<6> The processor as described in any one of <1> to <5>, further including a memory to which an execution result of the instruction by the instruction execution unit is written, wherein an execution result of the another instruction is not written to the memory.
<7> The processor as described in any one of <1> to <5>, further including an instruction hold unit configured to hold the instruction output by the instruction supply unit, wherein the another instruction is an instruction held in the instruction hold unit.
<8> The processor as described in <7>, wherein the another instruction is an instruction held in the instruction hold unit immediately before the instruction reception from the instruction supply unit is stopped.
<9> The processor as described in <7>, further including a memory to which an execution result of the instruction by the instruction execution unit is written, wherein the holding of the instruction output by the instruction supply unit includes holding the instruction by changing the instruction output by the instruction supply unit to an instruction for preventing the execution result from being written to the memory, and wherein the another instruction is the changed and held instruction.
<10> The processor as described in claim 7, wherein the instruction supply unit stops the output of the instruction and outputs, to the instruction selector, a selection signal for causing the instruction held in the instruction hold unit to be output, in response to detecting that there is no instruction to be output to the instruction execution unit.
<11> The processor as described in <7>, wherein the instruction supply unit stops instruction output and outputs, to the instruction selector, a selection signal for causing the instruction held in the instruction hold unit to be output, in response to receiving a wait instruction generated when the instruction execution unit cannot execute the instruction.
<12> The processor as described in <7>, further including a selection control unit configured to output, to the instruction selector, a selection signal for causing the instruction held in the instruction hold unit to be output, in response to detecting that the instruction supply unit outputs no instruction or the instruction execution unit cannot execute the instruction.
<13> The processor as described in any one of <1> to <5>, wherein the instruction selector outputs the another instruction to the instruction execution unit a plurality of times until the instruction reception from the instruction supply unit is restarted.
<14> The processor as described in any one of <1> to <5>, wherein the instruction execution unit includes a plurality of arithmetic units and operates as a single instruction multiple data (SIMD) processor.
<15> A method of controlling a processor including an instruction execution unit configured to execute an instruction and an instruction supply unit configured to output the instruction to be executed by the instruction execution unit, the method including outputting, by an instruction selector included in the processor, the instruction received from the instruction supply unit to the instruction execution unit, and outputting another instruction to the instruction execution unit, in response to detecting that instruction reception from the instruction supply unit is stopped.

What is claimed is:

1. A processor comprising:
an instruction execution circuit configured to execute an instruction;
an instruction supply circuit configured to output the instruction to be executed by the instruction execution circuit; and
an instruction selection circuit configured to output the instruction received from the instruction supply circuit to the instruction execution circuit, and output another instruction to the instruction execution circuit in response to detecting that instruction reception from the instruction supply circuit is stopped.

2. The processor as claimed in claim 1, wherein the another instruction is at least one of an instruction that is the same as a first instruction received from the instruction supply circuit before the instruction reception from the instruction supply circuit is stopped, an instruction based on the first instruction, or an instruction determined based on power consumption of the first instruction.

3. The processor as claimed in claim 2, wherein the first instruction is an instruction received from the instruction supply circuit immediately before the instruction reception from the instruction supply circuit is stopped.

4. The processor as claimed in claim 1, wherein the another instruction is an instruction determined based on power consumption.

5. The processor as claimed in claim 1, wherein the instruction selection circuit outputs the another instruction so that the instruction execution circuit continuously executes a same instruction two or more times, in response to detecting that the instruction reception from the instruction supply circuit is stopped.

6. The processor as claimed in claim 1, further comprising a memory to which an execution result of the instruction by the instruction execution circuit is written,
wherein an execution result of the another instruction is not written to the memory.

7. The processor as claimed in claim 1, further comprising an instruction hold circuit configured to hold the instruction output by the instruction supply circuit,
wherein the another instruction is an instruction held in the instruction hold circuit.

8. The processor as claimed in claim 7, wherein the another instruction is an instruction held in the instruction hold circuit immediately before the instruction reception from the instruction supply circuit is stopped.

9. The processor as claimed in claim 7, further comprising a memory to which an execution result of the instruction by the instruction execution circuit is written,
wherein the holding of the instruction output by the instruction supply circuit includes holding the instruction by changing the instruction output by the instruction supply circuit to an instruction for preventing the execution result from being written to the memory, and
wherein the another instruction is the changed and held instruction.

10. The processor as claimed in claim 7, wherein the instruction supply circuit outputs, to the instruction selection circuit, a selection signal for causing the instruction held in the instruction hold circuit to be output, in response to detecting that there is no instruction to be output to the instruction execution circuit.

11. The processor as claimed in claim 7, wherein the instruction supply circuit outputs, to the instruction selection circuit, a selection signal for causing the instruction held in the instruction hold circuit to be output, in response to receiving a wait instruction generated when the instruction execution circuit cannot execute an instruction.

12. The processor as claimed in claim 7, further comprising a selection control circuit configured to output, to the instruction selection circuit, a selection signal for causing the instruction held in the instruction hold circuit to be output, in response to detecting that the instruction supply circuit outputs no instruction or the instruction execution circuit cannot execute an instruction.

13. The processor as claimed in claim 1, wherein the instruction selection circuit outputs the another instruction to the instruction execution circuit a plurality of times until the instruction reception from the instruction supply circuit is restarted.

14. The processor as claimed in claim 1, wherein the instruction execution circuit includes a plurality of arithmetic units and operates as a single instruction multiple data (SIMD) processor.

15. A method of controlling a processor including an instruction execution circuit configured to execute an instruction and an instruction supply circuit configured to output the instruction to be executed by the instruction execution circuit, the method comprising:
outputting, by an instruction selection circuit included in the processor, the instruction received from the instruction supply circuit to the instruction execution circuit, and outputting another instruction to the instruction execution circuit, in response to detecting that instruction reception from the instruction supply circuit is stopped.

16. The method as claimed in claim 15, wherein the another instruction is at least one of an instruction that is the same as a first instruction received from the instruction supply circuit before the instruction reception from the instruction supply circuit is stopped, an instruction based on the first instruction, or an instruction determined based on power consumption of the first instruction.

17. The method as claimed in claim 15, wherein the another instruction is an instruction determined based on power consumption.

18. The method as claimed in claim 15, wherein the outputting of the another instruction includes outputting the another instruction so that the instruction execution circuit continuously executes a same instruction two or more times, in response to detecting that the instruction reception from the instruction supply circuit is stopped.

19. The method as claimed in claim 15, further comprising wiring, by the instruction execution circuit, an execution result of the instruction to a memory, wherein an execution result of the another instruction is not written to the memory.

20. The method as claimed in claim 15, further comprising holding, by an instruction hold circuit included in the processor, the instruction output by the instruction supply circuit,
wherein the another instruction is an instruction held in the instruction hold circuit.

21. The method as claimed in claim 15, wherein the outputting of the another instruction includes outputting the another instruction to the instruction execution circuit a plurality of times until the instruction reception from the instruction supply circuit is restarted.
